(19) United States
(12) Patent Application Publication
(10) Pub. No.: US 2025/0001362 A1
(43) Pub. Date: Jan. 2, 2025

(54) 3D-PRINTED PHOTOTHERMAL NANOCOMPOSITE SPACERS AND THEIR APPLICATION FOR SOLAR-DRIVEN MEMBRANE DISTILLATION

(71) Applicant: Khalifa University of Science and Technology, Abu Dhabi (AE)

(72) Inventors: Faisal Abdulla ALMARZOOQI, Abu Dhabi (AE); Seunghyun HONG, Abu Dhabi (AE); Noora Ali Abdulla Ahmed AL MARZOOQI, Abu Dhabi (AE); Andreas SCHIFFER, Abu Dhabi (AE)

(21) Appl. No.: 18/741,157

(22) Filed: Jun. 12, 2024

Related U.S. Application Data
(60) Provisional application No. 63/509,954, filed on Jun. 23, 2023.

(51) Int. Cl. B01D 61/36; B33Y 10/00; B33Y 40/10; C01B 32/921; C09D 11/037; C09D 11/101; C09D 11/107

(52) U.S. Cl. CPC B01D 61/366; B01D 61/364; B33Y 10/00; B33Y 40/10; C01B 32/921; C09D 11/037; C09D 11/101; C09D 11/107; B01D 2313/143; B01D 2313/22

(57) ABSTRACT

Titanium carbide (Ti₃C₂Tₓ) MXene nanocomposite spacers can be incorporated into membrane distillation systems. For example, a method can include selectively etching aluminum layers from layered ternary carbide powder by adding the ternary carbide powder in etchant to form a slurry. Additionally, the method can include centrifuging the slurry and washing the slurry until reaching a pH condition. Subsequent to reaching the pH condition, the method can include collecting a Ti₃C₂Tₓ MXene supernatant from the slurry. The method can further include vacuum drying the supernatant to produce Ti₃C₂Tₓ MXene powder. The method can include mixing the MXene powder with additional materials to form a nanocomposite ink with Ti₃C₂Tₓ MXene nanofillers. The method can further include printing a pattern with the nanocomposite ink to form a Ti₃C₂Tₓ MXene nanocomposite spacer.

### CROSS-REFERENCES TO RELATED APPLICATIONS

This application claims the benefit of U.S. Provisional Application No. 63/509,954, filed Jun. 23, 2023, the entire contents of which are hereby incorporated in their entirety for all purposes.

### BACKGROUND OF THE INVENTION

Technologies such as membrane distillation (MD) can act as an alternative to conventional high-cost and energy-intensive desalination technologies (e.g., Multi-Stage Flash, Reverse Osmosis, etc.) for brine treatment. MD technologies can provide improved energy efficiency, improved sustainability, and competitive economic feasibility compared to conventional desalination solutions, particularly in arid and desiccated regions, such as in the Middle East. Additionally, by employing desalination technologies that exploit renewable energy sources such as solar-driven power, a huge carbon footprint typically associated with conventional desalination approaches can be avoided.

MD can be described as a thermal separation process in which saline water is evaporated at atmospheric pressure by supplying feed energy in a form of heat. Water vapor can pass through hydrophobic microporous membranes. In the MD process, a feed stream of saline water can be separated from a pure water stream via a microporous membrane. A hydrophobic nature of the microporous membrane can stop mass transfer in a liquid phase and can create a vapor-liquid interface at a pore entrance so that only a gas phase can exist inside pores of the microporous membrane. Hence, volatile compounds can evaporate, diffuse across the membrane pores, and condense on an opposite side of the membrane.

A temperature gradient through the porous membrane can create a vapor pressure difference between two sides of the porous membrane. The vapor pressure difference can act as a driving force for water molecules to evaporate and diffuse through the porous membrane. Water vapor can flow from a hot side to a cold side where the water vapor can condense and get collected. Compared to other thermal-based processes, the MD process can exhibit advantages. These advantages can include a comparatively low operating pressure and temperature, a high percentage rejection of non-volatile components, and an ability to directly use renewable and waste energy sources.

MD approaches can include an energy efficient approach called surface heating membrane distillation (SHMD). Unlike traditional MD which can involve energy-intensive bulk feed heating, SHMD can employ renewable energy, potentially lowering operating costs dramatically. By using renewable energy, the SHMD approach can avoid or overcome problems associated with conventional MD systems. The problems associated with conventional MD systems can include an effect of temperature polarization, metal scaling and corrosion issues in heat exchangers that heat an inlet saline feed, and a costly energy used to heat-up large volumes of bulk solution. Hence, the SHMD approach can improve an overall performance of MD systems. Inlet feed temperature for MD systems with the SHMD approach can be close to room temperature (e.g., 20-30° C.).

Renewable energy sources, particularly solar energy sources, can provide an alternative to non-renewable fossil-fuel energy sources in MD systems. A feed solution of an MD system can be heated either before entering a membrane module through a use of solar collectors or directly in the membrane module by placing a solar absorber material in the MD system. Photothermal materials can be incorporated into surface-heating membranes, resulting in photothermal membranes. Major photothermal materials that can be applied in MD systems can include plasmonic metallic nanomaterials, inorganic semiconductor solar absorber materials, and carbon-based nanomaterials. The photothermal materials can absorb emitted photons from solar radiation across a solar spectrum wavelength range (e.g., 250-2500 nm). Absorption of photons can lead to an excitation of electrons in a bulk and a consequential increase in a surface temperature of the porous membrane. As a result, a photothermal membrane can enable a localized heating effect for entering feed solution in the MD system. A photothermal MD technique can reduce an input energy for water purification and can contribute to reducing up to 70% of an operating cost in MD systems.

### BRIEF SUMMARY OF THE INVENTION

Titanium carbide (Ti₃C₂Tₓ) MXene nanocomposite spacers can be incorporated into membrane distillation (MD) systems. For example, a method described herein can include selectively etching aluminum layers from layered ternary carbide powder by adding the ternary carbide powder in etchant to form a slurry. Additionally, the method can involve centrifuging the slurry and washing the slurry until reaching a pH condition. Subsequent to reaching the pH condition, the method can include collecting a Ti₃C₂Tₓ MXene supernatant from the slurry. The method can further include vacuum drying the Ti₃C₂Tₓ MXene supernatant to produce Ti₃C₂Tₓ MXene powder. The method can include mixing the Ti₃C₂Tₓ MXene powder with additional materials to form a nanocomposite ink with Ti₃C₂Tₓ MXene nanofillers. The method can also include printing a pattern with the nanocomposite ink to form a Ti₃C₂Tₓ MXene nanocomposite spacer.

In another example, a system described herein can include a Ti₃C₂Tₓ MXene nanocomposite spacer. The nanocomposite spacer can absorb light and can produce a thermal gradient to promote distilling of pure water from saline feed water. The nanocomposite spacer can include a nanocomposite material. The nanocomposite material can be 3D printed and can include Ti₃C₂Tₓ MXene nanofillers.

In another example, a membrane distillation (MD) system described herein can include a feed chamber exposed to a light source. The feed chamber can include saline feed water. The MD system can also include a condenser chamber on an opposite side of the feed chamber relative to the light source. The condenser chamber can include pure water. Additionally, the MD system can include a Ti₃C₂Tₓ MXene nanocomposite spacer. The nanocomposite spacer can be positioned between the feed chamber and the condenser chamber. Additionally, the nanocomposite spacer can absorb light from the light source. The nanocomposite spacer can also produce a thermal gradient to promote distilling of pure water from the saline feed water.

### BRIEF DESCRIPTION OF THE DRAWINGS

FIG. 1 is a schematic of a solar-driven SHMD system including a Ti₃C₂Tₓ MXene nanocomposite spacer according to some aspects of the present disclosure.

FIG. 2 is a schematic depicting stages of a fabrication process for synthesizing 3D-printed Ti₃C₂Tₓ MXene nanocomposite spacers according to some aspects of the present disclosure.

FIG. 3 is a scanning electron microscopy (SEM) image of a 3D-printed Ti₃C₂Tₓ MXene nanocomposite spacer according to some aspects of the present disclosure.

FIG. 4 is a transmission electron microscopy (TEM) image of Ti₃C₂Tₓ MXene nanosheets according to some aspects of the present disclosure.

FIG. 5 is a graph of a Raman spectrum for Ti₃C₂Tₓ MXene nanofillers embedded in a 3D-printed spacer according to some aspects of the present disclosure.

FIG. 6 is a graph of an X-ray photoelectron spectrum (XPS) for binding energies up to 750 eV for a fabricated Ti₃C₂Tₓ MXene film according to some aspects of the present disclosure.

FIG. 7 is a graph of particular regions of an XPS for stacked Ti₃C₂Tₓ MXene films according to some aspects of the present disclosure.

FIG. 8 is a graph of X-ray diffraction (XRD) patterns for a Ti₃C₂Tₓ lamellar film and for MAX phase powder.

FIG. 9 is a graph of mechanical stress-strain curves for dogbone specimens with varying Ti₃C₂Tₓ compositions according to some aspects of the present disclosure.

FIG. 10 is a graph of multiple mechanical properties for dogbone specimens with varying Ti₃C₂Tₓ compositions according to some aspects of the present disclosure.

FIG. 11 is a schematic of an experimental setup of a custom-built MD cell with a 3D-printed Ti₃C₂Tₓ MXene nanocomposite spacer according to some aspects of the present disclosure.

FIG. 12 is a graph of water production under illumination over 15-hour periods for a custom-built MD cell with a 3D-printed Ti₃C₂Tₓ MXene nanocomposite spacer according to some aspects of the present disclosure.

FIG. 13 is a graph of water vapor flux from accumulated distilled water measured after every 60-minute interval for a custom-built MD cell with a 3D-printed Ti₃C₂Tₓ MXene nanocomposite spacer according to some aspects of the present disclosure.

FIG. 14 is a graph of averaged water vapor flux for a custom-built MD cell with a 3D-printed Ti₃C₂Tₓ MXene nanocomposite spacer according to some aspects of the present disclosure.

FIG. 15 is a graph of a comparison of time dependence of feed saline temperature for a custom-built MD cell with a 3D-printed 2% Ti₃C₂Tₓ MXene nanocomposite spacer vs a 0% spacer according to some aspects of the present disclosure.

FIG. 16 is a graph of wavelength dependence on optical reflectance of printed nanocomposite plates with different compositions of Ti₃C₂Tₓ according to some aspects of the present disclosure.

FIG. 17 is a graph of photothermal response of 3D-printed Ti₃C₂Tₓ MXene nanocomposite spacers of various concentrations under different conditions according to some aspects of the present disclosure.

FIG. 18 is a graph depicting a comparison of time dependence of surface temperature for a 3D-printed 2% Ti₃C₂Tₓ MXene nanocomposite spacer vs a 0% spacer under different conditions according to some aspects of the present disclosure.

FIG. 19 is a double y graph of gain output ratio (GOR) and specific energy consumption (SEC) as functions of Ti₃C₂Tₓ MXene loading for a custom-built MD cell with a 3D-printed Ti₃C₂Tₓ MXene nanocomposite spacer of various loading concentrations according to some aspects of the present disclosure.

FIG. 20 is a flowchart of an example of a process for fabricating a titanium carbide (Ti₃C₂Tₓ) MXene nanocomposite spacer according to some aspects of the present disclosure.

### DETAILED DESCRIPTION OF THE INVENTION

Certain aspects of the present disclosure relate to titanium carbide (Ti₃C₂Tₓ) MXene nanocomposite spacers. The Ti₃C₂Tₓ MXene nanocomposite spacers can act as self-heaters under light. Additionally, Ti₃C₂Tₓ MXene nanocomposite spacers can act as turbulence promotors and enhance heat transfer and a resulting mass transfer in MD systems. A Ti₃C₂Tₓ MXene nanocomposite spacer can enhance an MD system that can be described as both an SHMD system and an air gap MD (AGMD) system. When an air gap is introduced between a membrane and a condensation side of an MD system, both thermal losses and operating costs can be reduced. The Ti₃C₂Tₓ MXene nanocomposite spacer can be 3D printed and can lead to an eight-fold flux enhancement in an air gap distillation process compared to system performance without a spacer.

Carbon-based materials such as carbon black (CB), carbon nanotubes (CNTs), graphene, and graphene oxide (GO) can be attractive photothermal materials due to properties such as broad light absorption, high stability, low weight, and low costs. MXenes can be described as a class of two-dimensional (2D) inorganic compounds. 2D MXenes can include atomically thin layers of transition metal carbides, nitrides, or carbonitrides. MXenes can accept a variety of hydrophilic termination groups. A 2D MXenes family can be an attractive alternative material for use in photothermal surface heating MD systems due to certain features. These certain features of MXenes can include high electrical conductivity and impressive mechanical properties, a bonding compatibility to various functionalized surfaces that can make MXenes hydrophilic, a high negative zeta potential, an ability to enable stable colloidal solutions in water, and an efficient absorption of electromagnetic waves. The 2D MXenes family can include Ti₃C₂Tₓ MXene.

More specifically, Ti₃C₂Tₓ MXene can be considered as a potential optimal photothermal material because of efficient broadband absorption across the solar spectrum and due to high solar-to-heat conversion efficiency. Photothermal conversion can take place via three mechanisms including a localized surface plasmon resonance (LSPR) effect, electron-hole generation and relaxation, and a conjugation or hyper-conjugation effect. The LSPR effect can typically take place in metallic nanoparticles such as gold or silver. Electron-hole generation and relaxation can mostly occur in narrow-bandgap semiconducting materials. The conjugation or hyper-conjugation effect can be responsible for photothermal conversion of several carbon nanomaterials, including CNTs and graphene, with conjugated structures. An outstanding electromagnetic wave absorption and a strong LSPR effect may be responsible for strong photothermal conversion properties observed in MXene materials.

By employing photothermal spacers including Ti₃C₂Tₓ as a nanofiller, the photothermal spacers can lead to an incremental flux and energy efficiency that increases under solar illumination with an amount of Ti₃C₂Tₓ present. For example, the incremental flux and energy efficiency can reach values of

$$0.49 \frac{kg}{{m}^{2} h}$$

and 30.6%, respectively. The observed increase in water flux, which cannot be caused by a small rise of bulk feed water under light, may be due to a strong localized heating of the feed occurring close to a Ti₃C₂Tₓ MXene nanocomposite spacer.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

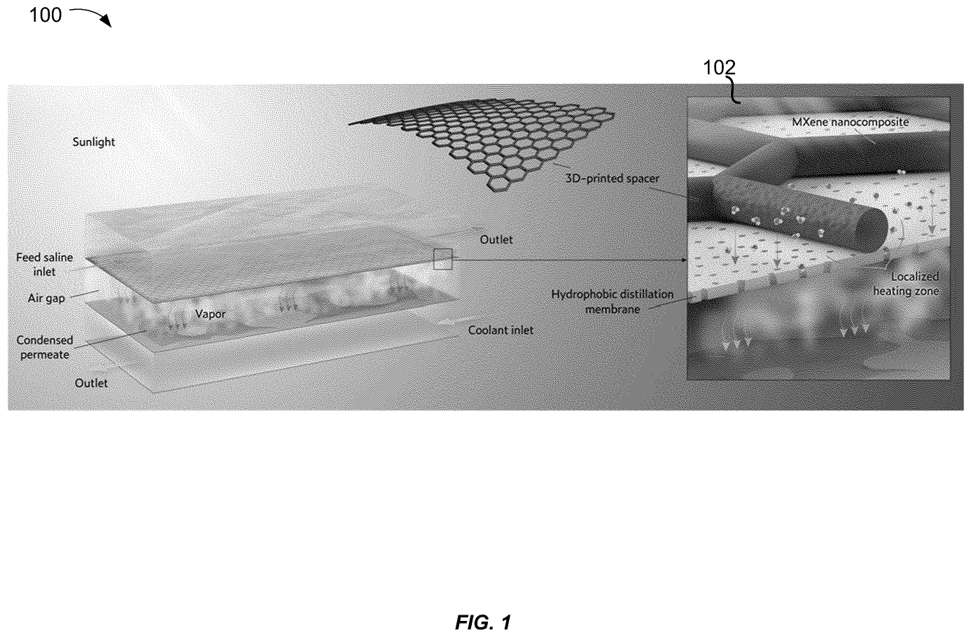

FIG. 1 is a schematic of a solar-driven SHMD system 100 including a Ti₃C₂Tₓ MXene nanocomposite spacer according to some aspects of the present disclosure. The solar-driven SHMD system 100 can include a feed chamber that includes a feed stream of saline water, the Ti₃C₂Tₓ MXene nanocomposite spacer, a hydrophobic distillation membrane, an air gap, and a bottom region of pure water. The Ti₃C₂Tₓ MXene nanocomposite spacer can include nanocomposite material comprising Ti₃C₂Tₓ MXene nanofillers. The nanocomposite material can be 3D-printed. The feed stream of saline feed water can flow from a feed saline inlet to a feed saline outlet in the top region. The pure water can flow from a coolant inlet to a coolant outlet in the bottom region. The pure water can flow in an opposite direction to the saline feed water stream flow.

An inset 102 of FIG. 1 depicts the Ti₃C₂Tₓ MXene nanocomposite spacer. The Ti₃C₂Tₓ MXene nanocomposite spacer can be 3D-printed in a pattern such as boundaries of honeycomb-like hexagonal openings. Under light irradiation, the 3D-printed Ti₃C₂Tₓ MXene nanocomposite spacer can photothermally create a localized heating zone near and surrounding the Ti₃C₂Tₓ MXene nanocomposite spacer. Saline in the feed water can be pressurized and water molecules in a vicinity of the localized heating zone can evaporate, diffuse across the membrane pores, pass through the air gap as water vapor, and condense in a form of condensed permeate on a top surface on the bottom region of pure water.

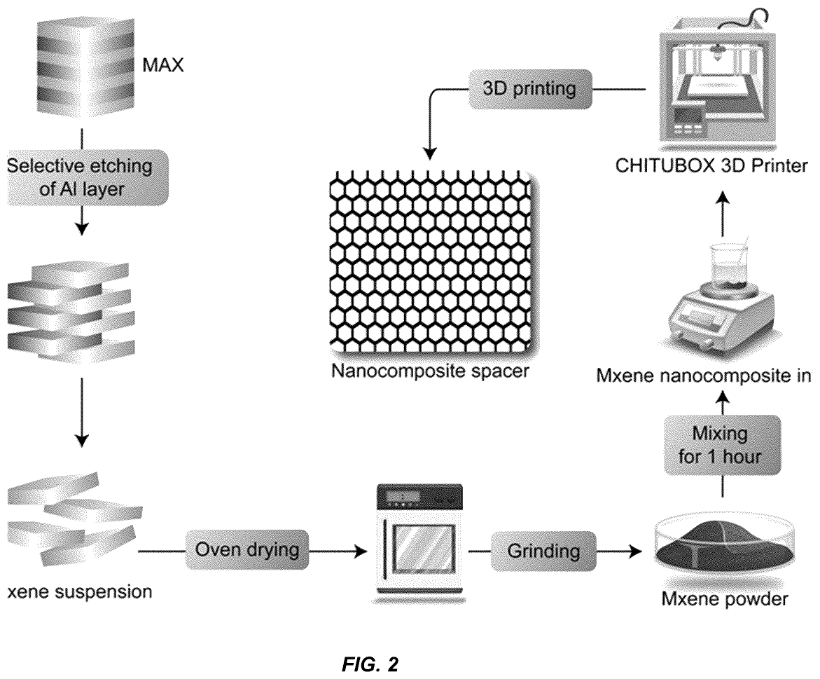

FIG. 2 is a schematic depicting stages of a fabrication process 200 for synthesizing 3D-printed Ti₃C₂Tₓ MXene nanocomposite spacers according to some aspects of the present disclosure. The fabrication process can begin by collecting a commercially available powder of layered ternary carbide Ti₃AlC₂ (MAX phase) powder. For example, the powder can come from Carbon-Ukraine Ltd. and can include particle sizes in a range from 40 μm to 100 μm.

The process can involve etching an aluminum layer of the MAX phase Ti₃AlC₂ using an etchant. In-situ HF-forming etchant can serve as one example of the etchant. The Ti₃AlC₂ etchant can be prepared by dissolving 1 gram of lithium fluoride (e.g., LiF 98% from Sigma Aldrich) in 10 to 12 milliliters of 9 to 12 mol/L hydrochloric (e.g., HCL 35-38% from Fisher Scientific). The Ti₃AlC₂ powder can be gently added and mixed in the as prepared etchant to form a slurry, at 38 to 40° C. for 24 hours. The slurry can be repeatedly centrifuged and washed at a relative centrifugal force (RCF) of 2600g (here g can refer to acceleration due to gravity) for 5 minutes with deionized water until a pH condition is reached. An example of the pH condition is a neutral pH value of 6. At the pH condition, a steady dark green supernatant of Ti₃C₂Tₓ can form. A final form of the Ti₃C₂Tₓ supernatant can be collected after repeated centrifugation of the Ti₃C₂Tₓ slurry obtained after the washing process at an RCF of 1000g for 15 to 30 minutes.

The process can involve vacuum drying the collected Ti₃C₂Tₓ solution. Vacuum drying can occur at a temperature of 80° C. while maintaining a pressure of 50 to 100 mbar. Under such conditions, water can entirely evaporate from the solution, and due to subsequent mechanical grinding, a powder form of Ti₃C₂Tₓ can be obtained. The process can involve mixing the powder form of Ti₃C₂Tₓ with additional materials for one hour to form MXene nanocomposite ink for a printing process.

In order to fabricate 3D-printed spacers using DLP 3D printing technology, a CHITUBOX 3D printer can be employed. The 3D-printed nanocomposite spacers can be printed using PlasCLEAR photopolymer (50 wt %), Tripropylene Glycol Diacrylate (TPGDA) diluents (with varying wt %), TPO photoinitiator (2.5 phr), and photothermally active nanofillers such as Ti₃C₂Tₓ MXene with an amount ranging from 0 to 5.0 wt %. All compounds can be mixed in a given proportion via magnetic stirring for 1 hour and bath sonification for 30 minutes. Formed resins are liquid-state chemicals that can be cured by exposure to ultraviolet (UV) light. Spacer structures can be fabricated by selectively curing feedstock resin layer-by-layer. CHITUBOX software can be employed to prepare a CAD model for a printing process by adding support structures. The 3D-printing process can be applied with process parameters summarized in Table 1. A slice thickness of 0.070 mm can be maintained to achieve high-resolution fabrication. A build chamber can be maintained at a temperature of 35° C. to control viscosity, reactivity, and a solidification process of the photopolymer. Once a 3D print is completed, specimens can be removed from a platform of the build chamber and remaining resin residue on the fabricated specimens can be removed with an isopropanol rinse. To increase cross-linking density, the fabricated 3D printed specimens can be post-cured for 6 minutes with a UV lamp.

TABLE 1
Process parameters for 3D-printing of plate-lattices

| Property | Amount | Unit |
|---|---|---|
| Light Intensity | 5.67 | $\frac{mW}{{cm}^{2}}$ |
| Exposure Time | 9.54 | s |
| Slice Thickness | 0.07 | mm |
| Heater Temperature | 35 | ° C. |
| Separation Velocity | 5 | $\frac{mm}{s}$ |
| Separation Distance | 14 | mm |

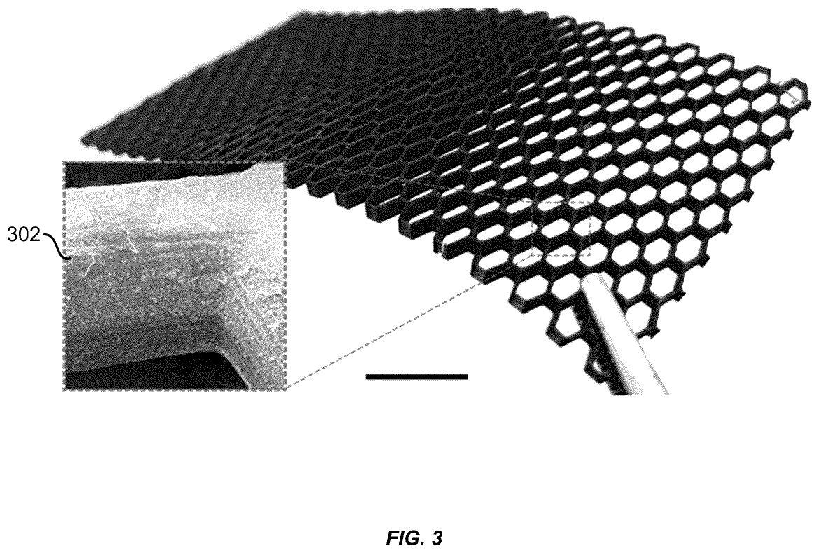

FIG. 3 is a scanning electron microscopy (SEM) image of a 3D-printed Ti₃C₂Tₓ MXene nanocomposite spacer according to some aspects of the present disclosure. Cross-sectional images of the Ti₃C₂Tₓ MXene nanocomposite spacer can be taken by breaking up the spacer with liquid nitrogen before placing pieces on a horizontal specimen holder. To avoid polymeric charging effects on surfaces, the pieces can be coated with a fixed 15 nm thick layer of Au/Pd using a Precision Etching Coating System (PECS 862 by Gatan) prior to making SEM measurements. Cross-sectional images can show a layered-like structure of spacer samples, and a distribution of Ti₃C₂Tₓ MXene nanosheets can be seen across a spacer body. An overall homogenous distribution of nanoparticles without agglomeration can be verified from SEM images.

The 3D-printed Ti₃C₂Tₓ MXene nanocomposite spacer can be equipped within an air gap membrane distillation module. By absorbing solar irradiation, the 3D-printed Ti₃C₂Tₓ MXene nanocomposite spacer can produce localized heating zones within a saline feed water and create a thermal gradient across membranes. The localized heating zones can evaporate water molecules in the saline feed water and the thermal gradient can produce a flux of permeating water vapor that enables a collection of a large amount of purified water with a high efficiency. The scale bar in FIG. 3 has a length of 10 mm. The fabricated 3D-printed Ti₃C₂Tₓ MXene nanocomposite spacers can have dimensions of 84×37×1.5 mm³ and possess honeycomb-like hexagonal openings. Inset 302 in FIG. 3 displays a microscopic image of a surface of a printed spacer, showing a distribution of Ti₃C₂Tₓ MXene nanosheets across the structure.

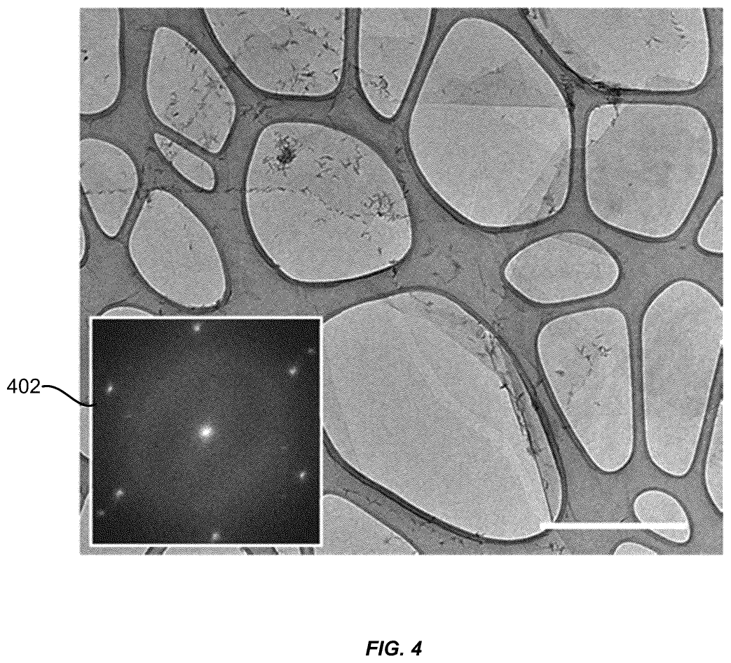

FIG. 4 is a transmission electron microscopy (TEM) image of Ti₃C₂Tₓ MXene nanosheets according to some aspects of the present disclosure. TEM images can confirm exfoliated and ultrathin MXene nanosheets with well-defined edges and a planar surface etched successfully from MAX-phase raw materials. The scale bar in FIG. 4 has a length of 1 micron. The TEM images can exhibit uniform surfaces without pinholes or foreign particles, suggesting high quality MXene material. Inset 402 of FIG. 4 is a Selected Area Electron Diffraction (SAED) image measurement that confirms that the Ti₃C₂Tₓ MXene nanosheets are successfully etched from MAX-phase Ti₃AlC₂ powder, thereby forming a monolayer configuration.

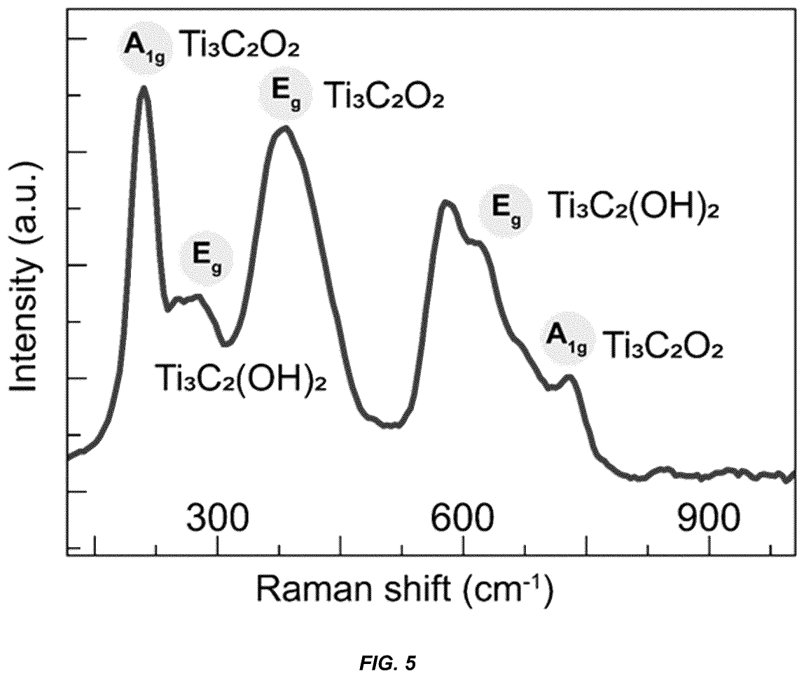

FIG. 5 is a graph of a Raman spectrum for Ti₃C₂Tₓ MXene nanofillers embedded in a 3D-printed spacer according to some aspects of the present disclosure. Raman spectroscopy can be a useful tool to detect lattice vibrations and molecular fingerprints. Additionally, Raman spectroscopy can help investigate surface terminal groups of MXene nanosheets. In the graph, peaks can be observed at 210, 278, 383, 619, and 726 1/cm. The observed peaks can be, respectively assigned to following vibration modes: A_{1g} of Ti₃C₂O₂, E_{g} of Ti₃C₂(OH)₂, E_{g} of Ti₃C₂O₂, E_{g} of Ti₃C₂(OH)₂, and A_{1g} of Ti₃C₂O₂.

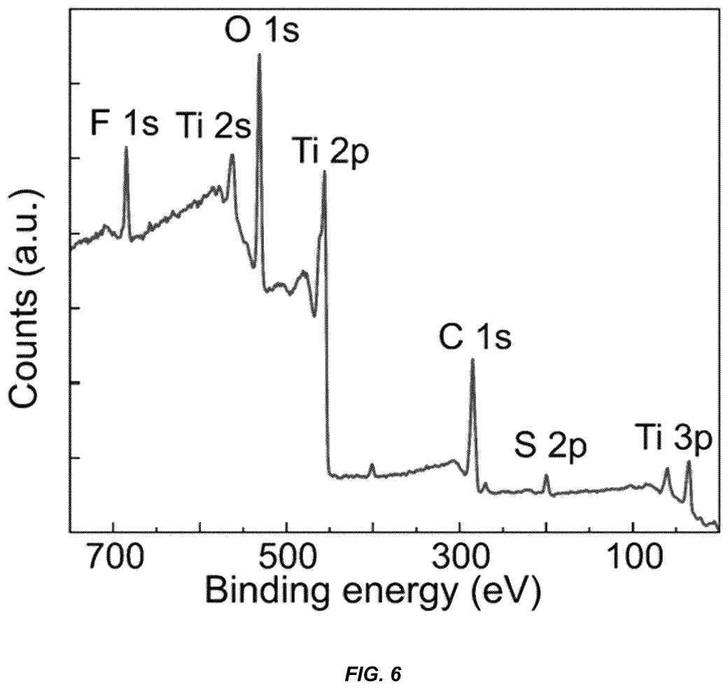

FIG. 6 is an XPS for binding energies up to 750 eV for a fabricated Ti₃C₂Tₓ MXene film according to some aspects of the present disclosure. The XPS data can support a presence of abundant surface terminal groups, including —O, —OH, and —F on surfaces of Ti₃C₂ nanosheets. These functional elements, that can also be observed in Raman spectra, can ensure MXene lamellar membranes are hydrophilic and negatively charged.

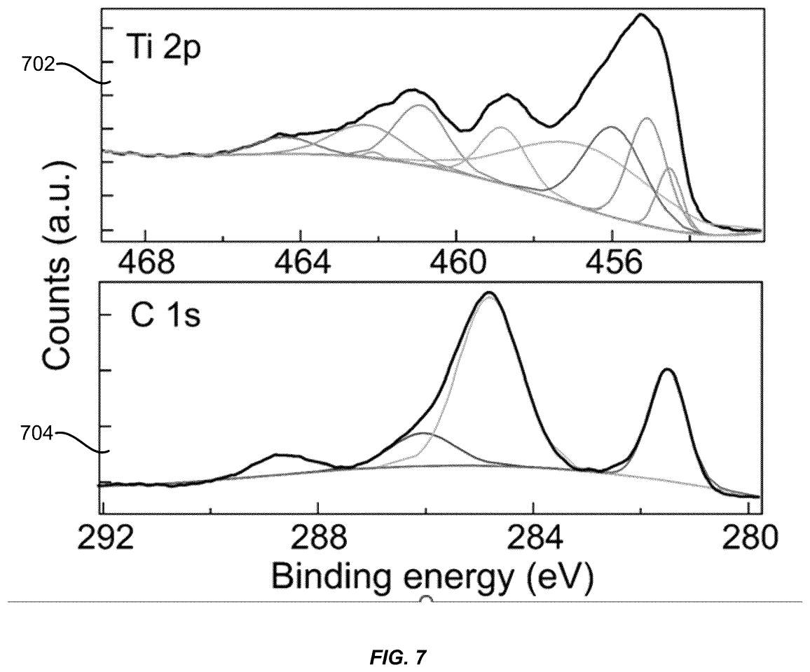

FIG. 7 is a graph of particular regions of an XPS for stacked Ti₃C₂Tₓ MXene films according to some aspects of the present disclosure. An upper graph 702 shows curve fitted spectra for a Ti2p region and a lower graph 704 shows curve fitted spectra for a C1s region. The Raman spectra data of FIG. 6 and FIG. 7 can suggest four possible moieties of surface termination existing on Ti₃C₂Tₓ lamellar films: C—Ti—Oₓ, C—Ti—(OH)ₓ, C—Ti—Fₓ, and Ti₃C₂OH—H₂O. Ti—C and Ti—O bonds can confirm a formation of Ti₃C₂Tₓ with oxygen-containing termination after an Aluminum etching process.

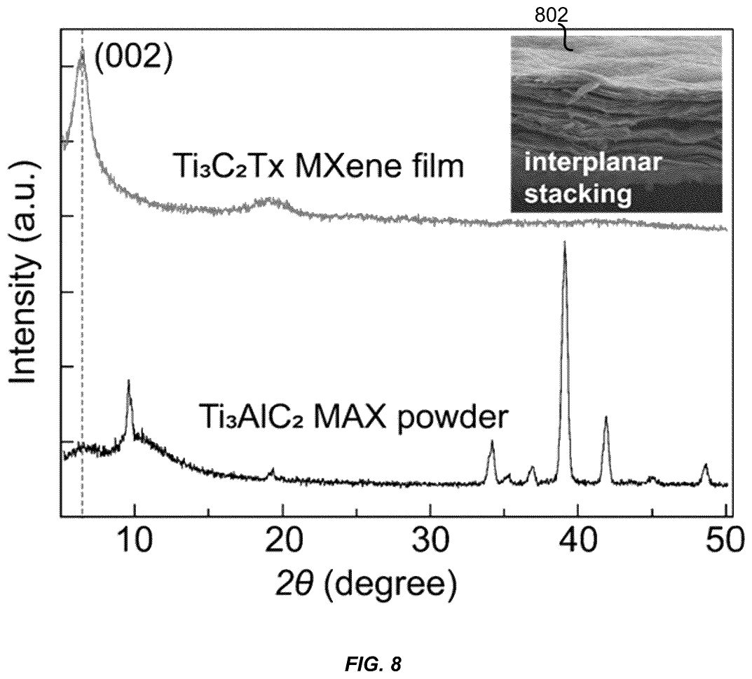

FIG. 8 is a graph of XRD patterns for a Ti₃C₂Tₓ lamellar film and for MAX phase powder. The XRD analysis can be carried out with a step scan of 0.05° and a step time of 2 seconds. A sharp (002) peak with high intensity can be seen in the XRD pattern of the Ti₃C₂Tₓ lamellar film and indicates a presence of ordered structure that may not be seen in the MAX phase powder. The XRD pattern may provide evidence that an exfoliation and delamination process can be successfully conducted. The 802 inset of FIG. 8 displays a lamellar structured film fabricated by vacuum-assisted filtration.

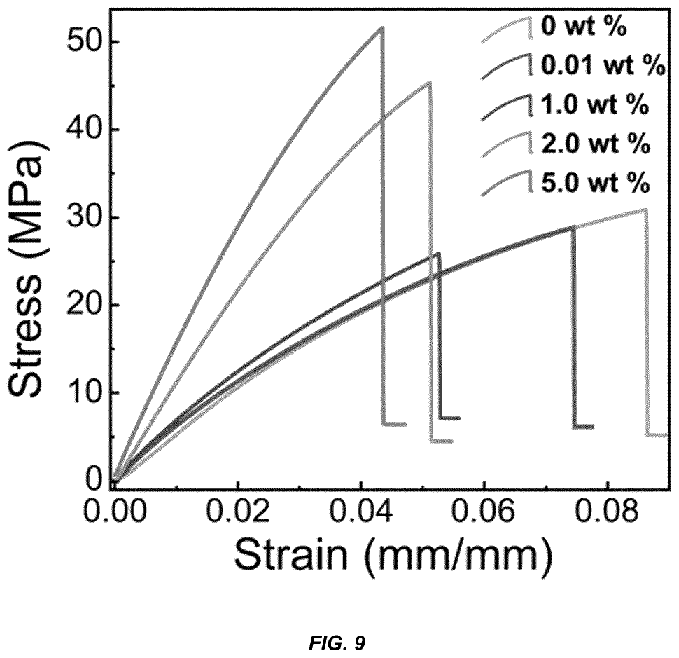

FIG. 9 is a graph of mechanical stress-strain curves for dogbone membrane specimens with varying Ti₃C₂Tₓ compositions according to some aspects of the present disclosure. A dogbone specimen can be a sample designed for mechanical testing that includes a shoulder at each end and a gauge section in between. The shoulders can be wider than the gauge section to induce a stress concentration in a center of the sample when a tensile force is applied. The dogbone specimens can be 3D-printed. The compositions can include 0.01, 1.0, 2.0, and 5.0 wt %. A Zwick-Roell universal testing machine (UTM) with a 2.5 kN load cell can be used to perform mechanical tests on the dogbone specimens and determine the multiple mechanical properties.

Even though an AGMD process can run at relatively low pressure, understanding mechanical endurance of spacers may be crucial since the spacers may be subject to unanticipated industrial flow disruptions. Furthermore, oxidative degradation by exposure to light or high temperatures can possibly impair inherent physical properties of MXenes and potentially affect photothermal conversion performance. A presence of a polymeric matrix in the spacers may impede oxidation of nanofiller Ti₃C₂Tₓ exposed to photothermal heating in an aqueous environment.

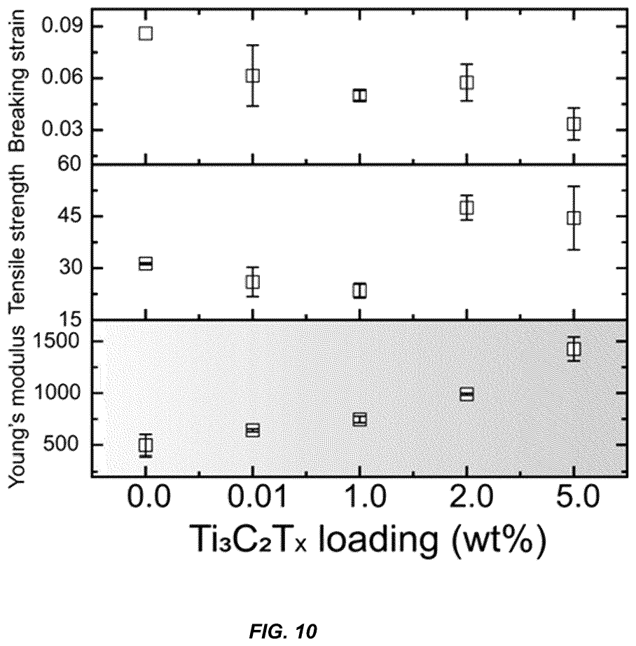

FIG. 10 is a graph of multiple mechanical properties for dogbone specimens with varying Ti₃C₂Tₓ compositions according to some aspects of the present disclosure. The mechanical properties can include breaking strain, tensile strength, and calculated Young's modulus. The compositions can include 0.01, 1.0, 2.0, and 5.0 wt %. A Zwick-Roell UTM with a 2.5 kN load cell can be used to perform mechanical tests on the dogbone specimens and determine the multiple mechanical properties. A dogbone specimen with a Ti₃C₂Tₓ composition of 5 wt % can show a breaking tensile strength of 51 MPa, which can even exceed breaking tensile strength values associated with polyvinylidene fluoride (PVDF) membranes. Monotonic tensile tests can be performed as per ASTM D638 Type V to evaluate the multiple mechanical properties. A crosshead speed can be kept constant at 2.5 mm/min and an elongation of specimens can be obtained from min crosshead displacement of the UTM.

### EXAMPLES

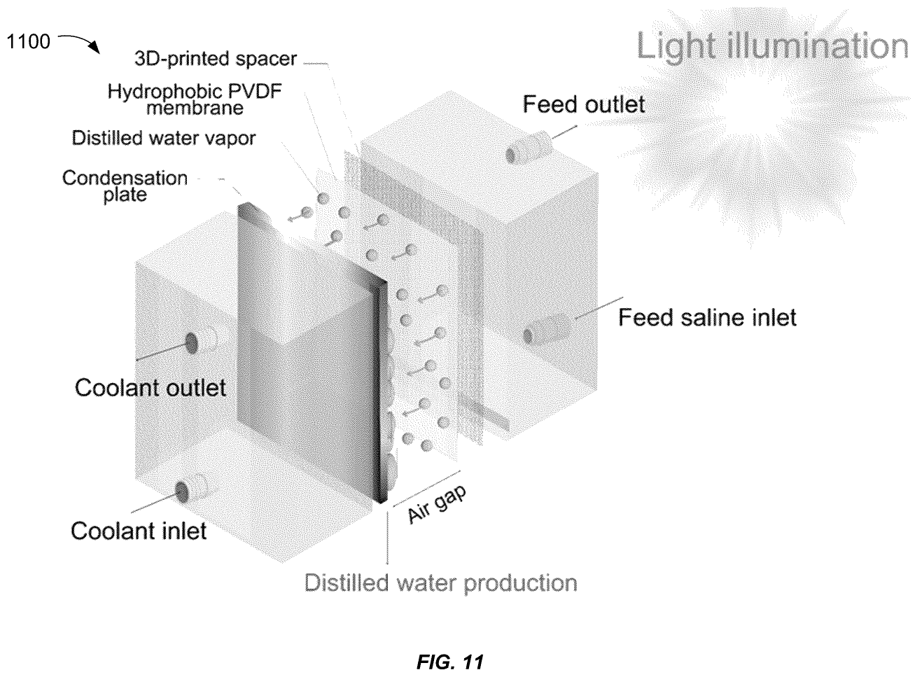

FIG. 11 is a schematic of an experimental setup 1100 of a custom-built MD cell with a 3D-printed Ti₃C₂Tₓ MXene nanocomposite spacer according to some aspects of the present disclosure. The custom-built MD cell can operate in AGMD mode. The experimental setup 1100 includes a solar simulator for a light source, a feed chamber, the 3D-printed Ti₃C₂Tₓ MXene nanocomposite spacer, a hydrophobic PVDF membrane, an air gap, a condensation plate, and a condenser chamber. Other materials may be used for the hydrophobic membrane including polypropylene, polytetrafluorethylene, photothermally convertible, or electrothermally convertible hydrophobic membranes. The feed chamber includes a feed saline inlet and a feed saline outlet for producing a continuous flow of saline feed water. The condenser chamber includes a coolant inlet and a coolant outlet for circulating pure water in the condenser chamber. The solar simulator can be a Newport Oriel 92190-1000 model.

Two peristaltic pumps were used to circulate feed and coolant solutions at a flow rate of 200 mL per minute. The saline feed water was prepared using Deionized water and a commercial sea salt (e.g., NaCl from Nezo) with a concentration of 35 g/L. The flowing feed was irradiated by the solar simulator set at a fixed power density of

$$1000 \frac{W}{{m}^{2}} .$$

Deionized water cooled down to 5° C. by a chiller (e.g., Grant instruments model TXF200-R4) can be continuously circulated in the condenser to induce condensation of vapors within the condenser side. Permeated vapors can condense and be collected through the air gap, and a resulting cumulative mass of condensed pure water was measured with a microbalance (e.g., Sartorius Secura microbalance) at constant time intervals. Temperatures of hot and cold streams can be monitored continuously using thermometers. Salt rejection could be calculated by measuring conductivity, using a conductivity meter (e.g., Omega model CDH-SD1), of the feed saline solution or the pure water solution at both the start and end of each experiment. Permeate flux can be determined and calculated based on collected permeate water mass.

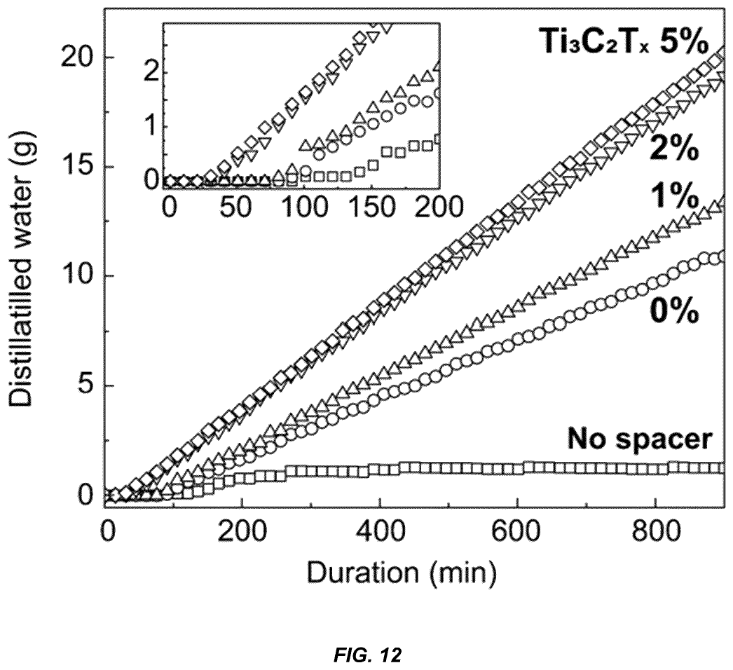

FIG. 12 is a graph of water production under illumination over 15-hour periods for a custom-built MD cell with a 3D-printed Ti₃C₂Tₓ MXene nanocomposite spacer according to some aspects of the present disclosure. A feed chamber of the custom-built MD cell was irradiated by the solar simulator set at a fixed power density of

$$1000 \frac{W}{{m}^{2}} .$$

The graph depicts results for different spacers with concentration amounts of Ti₃C₂Tₓ varying from 0 to 5.0 wt %. The graph also shows distillation results for the MD cell without a spacer. Photothermal distillation depicted by the graph can indicate a clear dependence of water production on incremental inclusion of Ti₃C₂Tₓ MXene with a saturated distillation beyond 2.0 wt %.

An inset 1202 of FIG. 12 is a zoomed in view of a first 200 minutes of the graph and provides insight on distillation response time. Distillation response time can indicate an amount of time that elapses before a distilled water flux starts to collect in the custom-built MD cell. The inset 1202 reveals that response time can decrease with increased concentration of Ti₃C₂Tₓ MXene, as expected. The 2 wt % nanocomposite spacer started to produce the flux after 30 minutes, whereas the bare nanocomposite spacer (0 wt %) exhibited vapor transport after 90 minutes. Interestingly, the MD cell without a spacer exhibited much lower distillation production performance of around 1.2 grams compared to even the nanocomposite spacer with no filler (0 wt %). This lower production performance may imply that the feed flow in a presence of fluidic spacers may be more efficient at absorbing solar input due to increased turbulent flow. The nanocomposite spacer may act as a turbulence promoter. Presence of the nanocomposite spacer can improve a heat transfer coefficient and suppress temperature polarization, which can result in increased mass transfer and permeate flow.

An analytical equation can be used to predict a feed temperature increase due to incoming energy absorption:

$$Δ {T}_{feed} = \frac{{E}_{in} \cdot A}{{Q}_{feed} \cdot C}$$

where ΔT_{feed} is a bulk feed temperature change in Kelvins; Eᵢₙ is a power density of incident light with units of

$$\frac{J}{{m}^{2} s} or \frac{kW}{{m}^{2}} ;$$

A is irradiation area in m²; Q_{feed} is feed flow rate in g/s; and C is heat capacity of water

$$( 4.1 \; 78 \frac{J}{g \cdot K} ) .$$

Under conditions of an experimental setup (as described in FIG. 11), estimated bulk feed temperature can be very small, such as 0.16 Kelvin with an assumption that 100% of incoming light is converted to thermal energy used to heat bulk feed water. This small temperature increase cannot account for an observed flux increase due to nanocomposite spacers as shown in FIG. 12. The significant flux increases that may be driven by the use of the nanocomposite spacers can imply that spacers assist in raising a temperature polarization coefficient. The temperature polarization coefficient can be roughly equivalent to distilled water flux under an assumption of a constant vapor flux in an absence of light. Also, the higher-than-expected water flux from MXene nanocomposite spacers can suggest that heating of the feed water due to the photothermal spacers may be highly localized at an interface between the nanocomposite spacer and background feed.

$$\frac{{α}_{T P}^{′} - {α}_{T P}}{{α}_{T P}} = \frac{Δ {T}_{F S - PS}^{′} - Δ {T}_{F S - P S}}{Δ {T}_{FS - PS}} \approx \frac{Δ {P}_{F S - PS}^{′} - Δ {P}_{F S - P S}}{Δ {P}_{FS - PS}} = \frac{{J}^{′} - J}{J} \times 100 \%$$

where a′_{TP} and a_{TP} are temperature polarization coefficients with and without light illumination; ΔT′_{FS-PS} and ΔT_{FS-PS} are membrane surface temperature gradients across the feed side to the permeate side with and without light illumination; ΔP′_{FS-PS} and ΔP_{FS-PS} are vapor pressure gradients across the feed to the permeate side of the membrane with and without light illumination; and J′ and J are the vapor flux with and without light illumination.

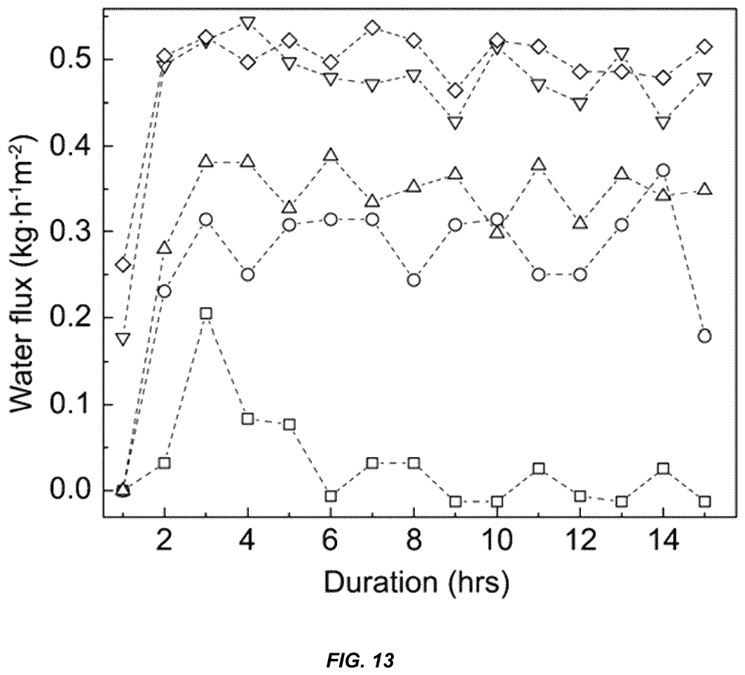

FIG. 13 is a graph of water vapor flux from accumulated distilled water measured after every 60-minute interval for a custom-built MD cell with a 3D-printed Ti₃C₂Tₓ MXene nanocomposite spacer according to some aspects of the present disclosure. A feed chamber of the custom-built MD cell was irradiated by the solar simulator set at a fixed power density of

$$1000 \frac{W}{{m}^{2}} .$$

The graph depicts results for different spacers with concentration amounts of Ti₃C₂Tₓ varying from 0 to 5.0 wt %. The graph also shows results for the MD cell without a spacer. Data associated with each of the four spacers indicates a stable productivity after around two hours and the stable values of flux increase with the concentration amounts of Ti₃C₂Tₓ. A gradual increase in flux, observed prior to each of the plateaus, can be attributed to a thermal equilibrium process between photothermal spacers and the feed saline while illuminated.

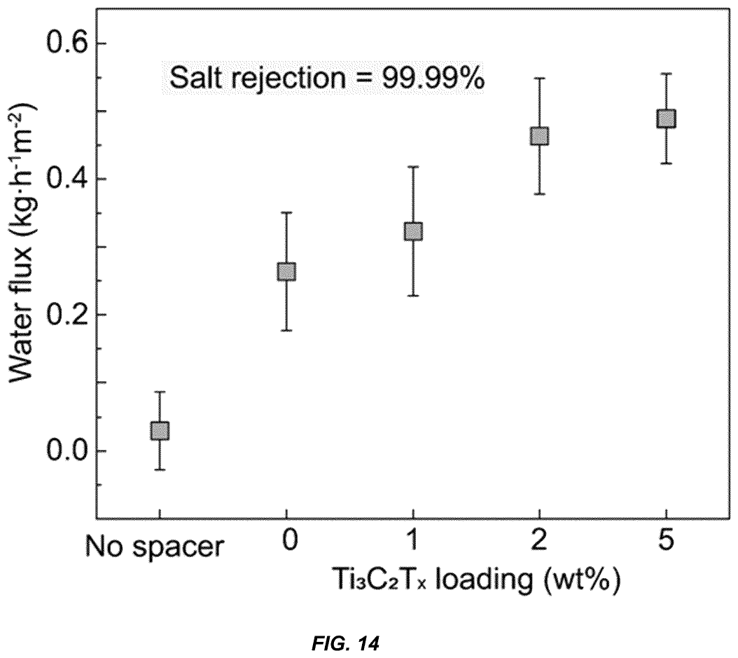

FIG. 14 is a graph of averaged water vapor flux for a custom-built MD cell with a 3D-printed Ti₃C₂Tₓ MXene nanocomposite spacer according to some aspects of the present disclosure. A feed chamber of the custom-built MD cell was irradiated by the solar simulator set at a fixed power density of

$$1000 \frac{W}{{m}^{2}} .$$

The graph depicts results for different spacers with concentration amounts of Ti₃C₂Tₓ varying from 0 to 5.0 wt %. The graph also shows results for the MD cell without a spacer. The bare spacer exhibited an average vapor flux of

$$0.26 \frac{k g}{{m}^{2} h} .$$

The 5 wt % Ti₃C₂Tₓ MXene spacer yielded the highest average vapor flux of

$$0.49 \frac{k g}{{m}^{2} h} ,$$

followed by the 2 wt % Ti₃C₂Tₓ with a value of

$$0.46 \frac{k g}{{m}^{2} h} ,$$

and the 1 wt % Ti₃C₂Tₓ spacer exhibited a value of

$$0.32 \frac{k g}{{m}^{2} h} .$$

The values were determined for a feed salinity of 35 g/L and a membrane area of 0.002756 m². For both the bare and Ti₃C₂Tₓ MXene nanocomposite spacer, salt rejection based on measured conductivity of distilled water was found to be 99.99%.

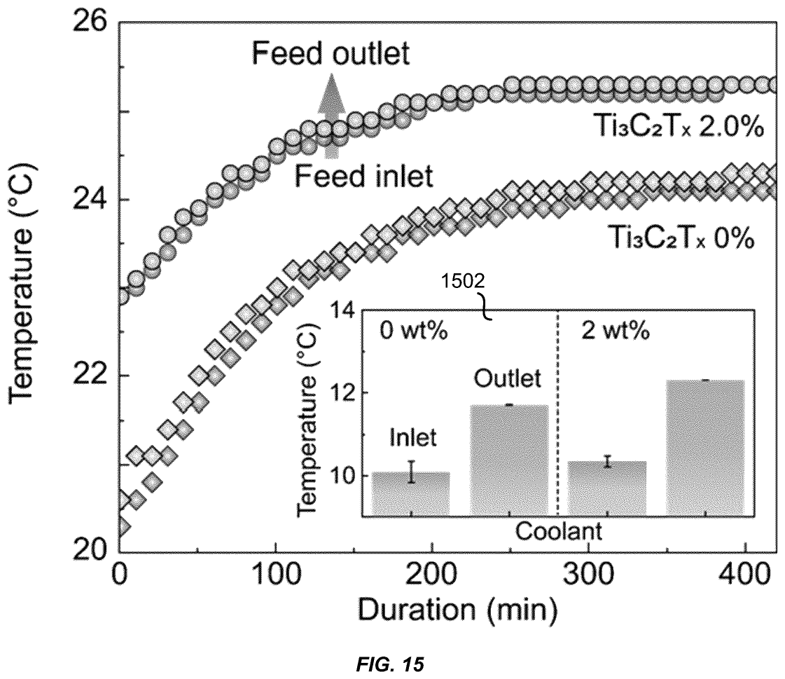

FIG. 15 is a graph of a comparison of time dependence of feed saline temperature for a custom-built MD cell with a 3D-printed 2% Ti₃C₂Tₓ MXene nanocomposite spacer vs a 0% spacer according to some aspects of the present disclosure. For both the bare and the 2% nanocomposite spacer, a temperature profile gradually increased to a plateau value after about two hours, which is similar to a temporal behavior depicted in FIG. 13. The higher temperature of the feed saline for the 2% nanocomposite spacer can provide strong evidence of photothermal heating effects by Ti₃C₂Tₓ MXene fillers under light illumination, which can enable a higher water vapor flux. Inset 1502 shows measured values of inlet and outlet temperatures of the coolant solution for both the bare and the 2% nanocomposite spacer. A higher temperature of the coolant outlet, measured for the 2% nanocomposite spacer, may be due to a higher vapor flux in conjunction with more frequent heat transfer across a cooling plate of the custom-built MD cell.

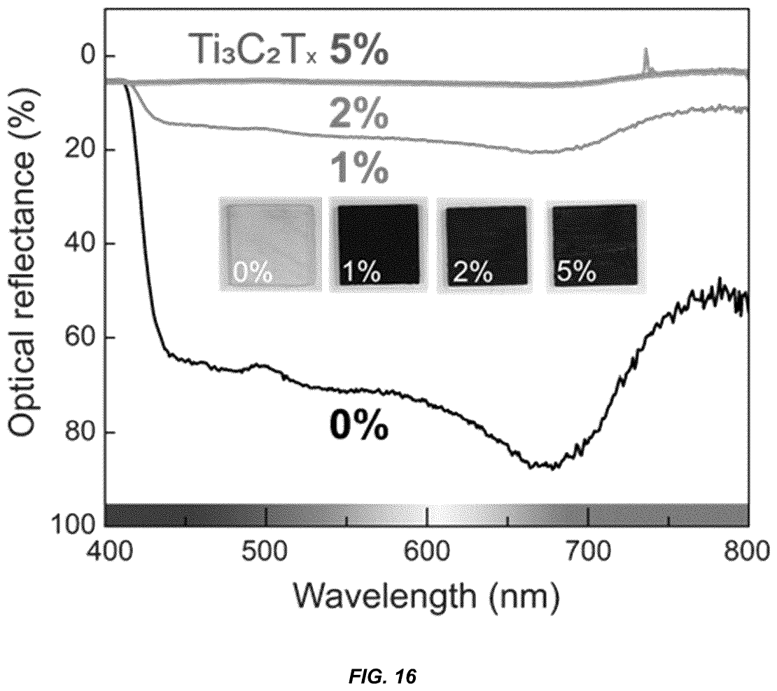

FIG. 16 is a graph of wavelength dependence on optical reflectance of printed nanocomposite plates with different compositions of Ti₃C₂Tₓ according to some aspects of the present disclosure. The graph depicts results for different spacers with concentration amounts of Ti₃C₂Tₓ varying from 0 to 5.0 wt %. As the concentration amounts increase from 0 to 5.0 wt % in a polymeric matrix, optical reflectance sharply decreased especially in a visible spectral range of 400-800 nm. Nanocomposite spacers with 2 wt % and 5 wt % of Ti₃C₂Tₓ MXene exhibited diffuse reflectance of 5.2% and 4.9% respectively. Since Ti₃C₂Tₓ MXene can exhibit efficient and broadband absorption across an entire solar spectrum, observed photothermal heating from Ti₃C₂Tₓ MXene nanocomposite spacers can be attributed to strong optical absorption by the Ti₃C₂Tₓ MXene fillers in the nanocomposite spacers. Additionally, when submerged in an aqueous environment, a darkening effect may improve optical absorption of the nanocomposite spacers. The improved optical absorption can lead to stronger photothermal heating. The darkening effect may be due to a considerable decrease in interfacial light scattering from a liquid-to-solid interface compared to an air-to-solid interface.

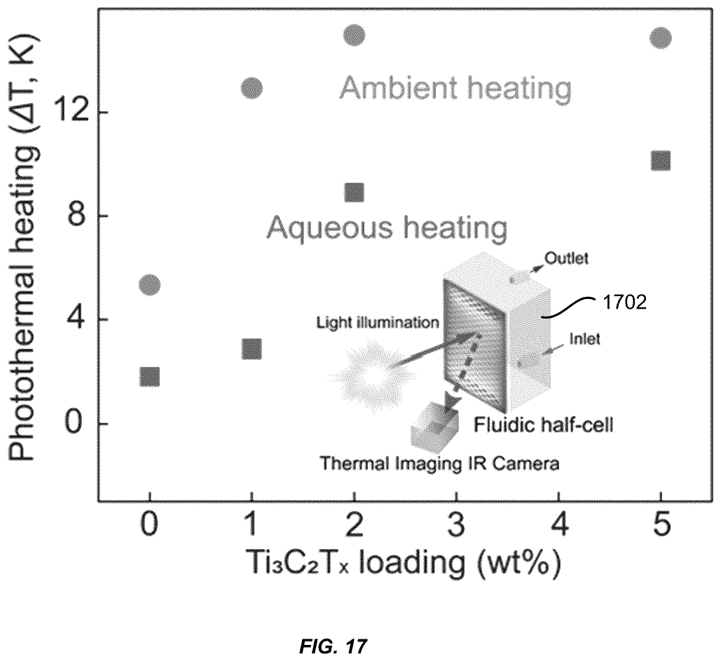

FIG. 17 is a graph of photothermal response of 3D-printed Ti₃C₂Tₓ MXene nanocomposite spacers of various concentrations under different conditions according to some aspects of the present disclosure. One of the different conditions includes ambient heating of the nanocomposite spacers on a half MD cell (as depicted in inset 1702). The half MD cell can include all components of a MD cell except the components related to a feed chamber. The other one of the different conditions includes aqueous heating of the nanocomposite spacers within the MD cell, which can also include the feed chamber.

The photothermal response was acquired directly from the nanocomposite spacers using an infrared camera (e.g., a FLIR C5 thermal imaging camera). Under ambient heating, the nanocomposite spacers exhibited an incremental change in photothermal response with increased concentration of Ti₃C₂Tₓ MXene, ranging from a value of 5.34 K for a 0% Ti₃C₂Tₓ MXene spacer to 10.84 K for a 2% Ti₃C₂Tₓ MXene spacer. No water evaporation can occur during the ambient heating condition, thus an increasing trend in the photothermal response can indicate a light-driven surface heating effect in a presence of Ti₃C₂Tₓ MXene in the nanocomposite spacers.

Under the aqueous heating condition, the nanocomposite spacers exhibited a change in photothermal response with increased concentration of Ti₃C₂Tₓ MXene, ranging from a value of 1.83 K for a 0% Ti₃C₂Tₓ MXene spacer to 8.91 K for a 2% Ti₃C₂Tₓ MXene spacer. A plateau trend can be observed beyond 2% Ti₃C₂Tₓ MXene under both conditions.

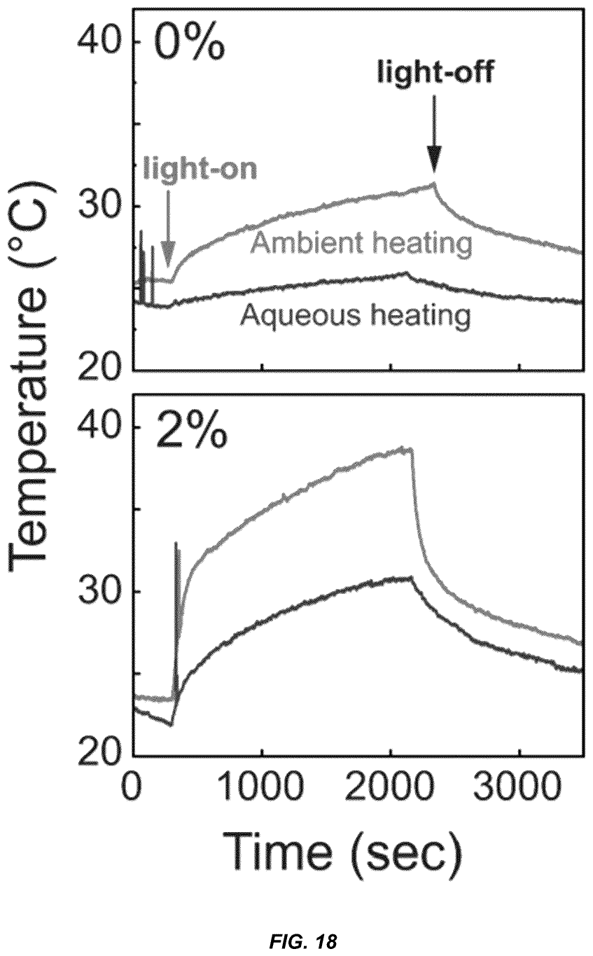

FIG. 18 is a graph depicting a comparison of time dependence of surface temperature for a 3D-printed 2% Ti₃C₂Tₓ MXene nanocomposite spacer vs a 0% spacer under different conditions according to some aspects of the present disclosure. The different conditions include an ambient heating condition and an aqueous heating condition. Both conditions are described in more detail above in a description of FIG. 17. An upper plot in FIG. 18 indicates an instance that a light source is turned on to illuminate the nanocomposite spacer and an instance when the light source is turned off. Under both of the conditions, the 2% Ti₃C₂Tₓ MXene spacer exhibits a stronger photothermal response than the 0% spacer as indicated by a larger slope in the temperature curves while under illumination. A temperature difference between ambient heating and aqueous heating evident in both plots can indicate thermal conduction from heated nanocomposite spacers to bulk feed solution, which is responsible for vaporization flux values observed for Ti₃C₂Tₓ MXene nanocomposite spacers.

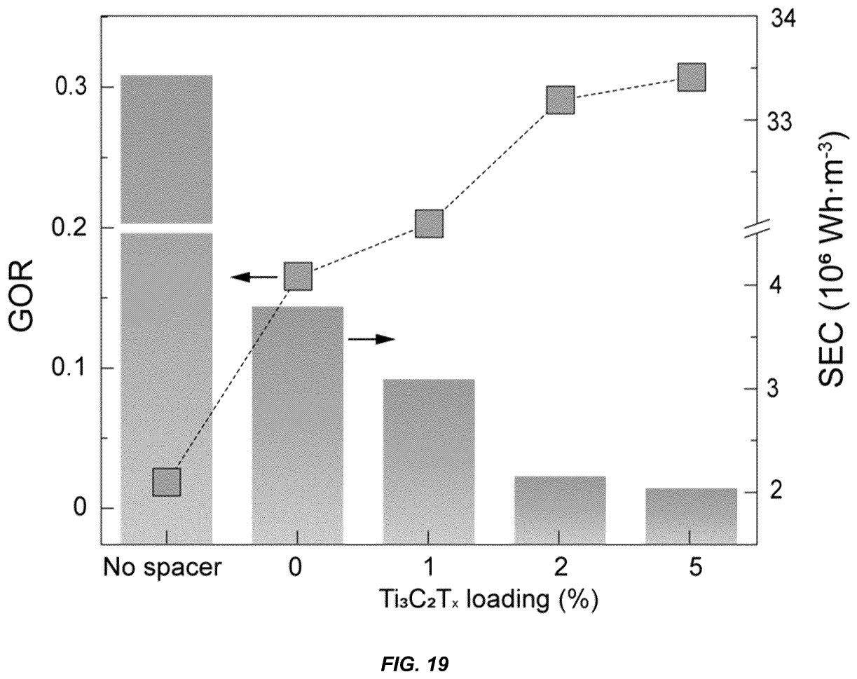

FIG. 19 is a double-y graph of GOR and specific energy consumption (SEC) as functions of Ti₃C₂Tₓ MXene loading for a custom-built MD cell with a 3D-printed Ti₃C₂Tₓ MXene nanocomposite spacer of various loading concentrations according to some aspects of the present disclosure. Energy conversion efficiency of solar thermal approaches to water distillation using the nanocomposite spacers can be investigated. Upon solar illumination, the Ti₃C₂Tₓ MXene-induced photothermal interaction of the nanocomposite spacers can offer thermal energy mostly to feed saline but to a membrane surface as well, leading to an increase in feed temperature and subsequent evaporative pressure across hydrophobic pores of the membrane. A portion of the generated heat by the nanocomposite spacers can be transferred and lost to a coolant pad of a condenser via radiative heat transfer in an air gap. Subsequently, a temperature of the condenser/coolant can increase. Thus, a total solar-to-thermal energy from the nanocomposite spacer can be understood as a sum of latent heat of water condensation, a feed temperature increment, and a radiative heat loss through the air gap.

Energy efficiency can be investigated by determining GOR. GOR can be defined as a ratio of energy expended for freshwater production to that of total input energy by solar irradiation or Eᵢₙ. An amount of total energy supplied with respect to produced distilled water can also be evaluated with SEC. Expressions for GOR and SEC can be given by:

$$GOR = \frac{{\dot{m}}_{d} {h}_{f g}}{{E}_{i n}}$$

$$SEC = \frac{{E}_{i n}}{{\dot{m}}_{d}}$$

where ma is distilled water flux (with units of

$$\frac{k g}{{m}^{2} h} )$$

and h_{fg} is latent heat for water vaporization (with units of kJ/kg).

Data displayed in FIG. 19 presents photothermal efficiencies (based on GOR) from respective nanocomposite spacers as well as involved SEC for producing freshwater by localized photothermal heating. The nanocomposite spacers showed a proportionally increasing energy efficiency to water flux. The 5 wt % Ti₃C₂Tₓ MXene nanocomposite spacer exhibited a highest efficiency of 30.6% for light intensity of

$$1000 \frac{W}{{m}^{2}} .$$

The efficiency of the 5 wt % Ti₃C₂Tₓ MXene nanocomposite spacer corresponds to an increased performance by 85.4% compared to the 0 wt % Ti₃C₂Tₓ MXene nanocomposite spacer. The SEC data indicated that energy demand can decline by increasing an amount of Ti₃C₂Tₓ nanosheets in the nanocomposite spacer, which can suggest that incorporation of 2D MXene as photofiller can be an effective strategy for energy efficient and sustainable water distillation. The 5 wt % Ti₃C₂Tₓ MXene nanocomposite spacer manifested a highest photothermal efficiency and lowest energy consumption in comparison to other Ti₃C₂Tₓ MXene nanocomposite spacers.

By reducing sizes of meshes in spacers, optical absorption as well as derived photothermal heating effects may greatly increase, and evaporative water flux can be improved. Longer fluid residence times can boost energy transport from the nanocomposite spacers to feed saline and evaporative water flux. The longer fluid residence times may be achieved by lowering feed flow rate or increasing turbulence derived fluidic resistance with smaller mesh sizes. Higher light power density and preheated feed water may also be employed to enhance solar-thermal power flux.

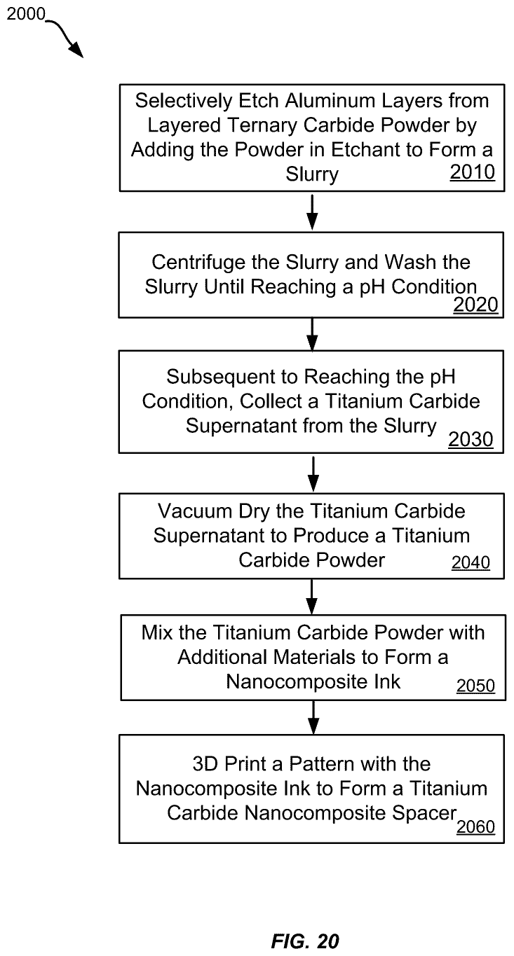

FIG. 20 is a flowchart of an example of a process 2000 for fabricating a titanium carbide (Ti₃C₂Tₓ) MXene nanocomposite spacer according to some aspects of the present disclosure. Operations of processes may be performed by software, firmware, hardware, or a combination thereof. The operations of the process 2000 start at block 2010.

At block 2010, the process 2000 involves selectively etching aluminum layers from layered Ternary Carbide Ti₃AlC₂ (MAX phase) powder by adding the powder to an etchant to form a slurry. A commercially available powder of the layered Ti₃AlC₂ (MAX phase) can be collected. For example, the powder can come from Carbon-Ukraine Ltd. and can include particle sizes in a range from 40 μm to 100 μm.

An in-situ HF-forming etchant can serve as the etchant. The Ti₃AlC₂ etchant can be prepared by dissolving one gram of lithium fluoride (e.g., LiF 98% from Sigma Aldrich) in 10 to 12 milliliters of 9 to 12 mol/L hydrochloric (e.g., HCL 35-38% from Fisher Scientific). The Ti₃AlC₂ (MAX phase) powder can be gently added and mixed, at 38 to 40° C. for 24 hours, in the as prepared etchant to form a slurry.

At block 2020, the process 2000 involves centrifuging and washing the slurry until reaching a pH condition. The slurry can be repeatedly centrifuged and washed at a RCF of 2600·g for 5 minutes with deionized water until the pH condition is reached. An example of the pH condition is a neutral pH value of 6.

At block 2030, the process 2000 involves collecting a Ti₃C₂Tₓ supernatant from the slurry subsequent to reaching the pH condition. At the pH condition, a steady dark green supernatant of Ti₃C₂Tₓ can form. The Ti₃C₂Tₓ supernatant can be collected after repeated centrifugation of the Ti₃C₂Tₓ slurry obtained after a washing process at an RCF of 1000g for 15 to 30 minutes.

At block 2040, the process 2000 involves vacuum drying the Ti₃C₂Tₓ supernatant to produce a Ti₃C₂Tₓ powder. Vacuum drying can occur at a temperature of 80° C. while maintaining a pressure of 50 to 100 mbar. Under such conditions, water can entirely evaporate from solution. The powder can be formed by grinding.

At block 2050, the process 2000 involves mixing the Ti₃C₂Tₓ powder with additional materials to form a nanocomposite ink. The additional materials can include PlasCLEAR photopolymer (e.g., 50 wt %), Tripropylene Glycol Diacrylate (TPGDA) diluents (of varying wt %), and TPO photoinitiator (e.g., 2.5 phr). The additional materials can be mixed with Ti₃C₂Tₓ powder as photothermally active nanofillers in an amount ranging from 0 to 5.0 wt %. All components can be mixed via magnetic stirring for 1 hour and a bath sonification for 30 minutes. Formed resins can be liquid-state chemicals that can be cured by exposure to UV light. Feedstock resin can be selectively cured layer-by-layer.

At block 2060, the process involves 3D printing a pattern with the nanocomposite ink to form a (Ti₃C₂Tₓ) MXene nanocomposite spacer. CHITUBOX software can be employed to prepare a CAD model for a 3D printing pattern by adding support structures. The pattern can include boundaries of shaped openings. Examples of shaped openings include honeycomb-like hexagonal, square, diamond, triangular, circular, or rectangular openings. The 3D printing process can be applied with process parameters summarized in Table 1. A slice thickness of 0.070 nm can be maintained to achieve high-resolution fabrication. A build chamber can be maintained at a temperature of 35° C. to control viscosity, reactivity, and a solidification process of the photopolymer. Once a 3D print is complete, specimens can be removed from a platform of the build chamber and remaining residue on the fabricated specimens can be removed with an isopropanol rinse. To increase cross-linking density, the fabricated 3D printed spacers can be post-cured, for example by exposing the spacers to a UV lamp for six minutes.

In the preceding description, various embodiments have been described. For purposes of explanation, specific configurations and details have been set forth in order to provide a thorough understanding of the embodiments. However, it will also be apparent to one skilled in the art that the embodiments may be practiced without the specific details. Furthermore, well-known features may have been omitted or simplified in order not to obscure the embodiment being described.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes and workflows disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the description to provide a thorough understanding of the embodiments. However, it will be understood that the embodiments may be practiced without these specific details. For example, specific computational models, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A method for fabricating a titanium carbide (Ti₃C₂Tₓ) MXene nanocomposite spacer comprising:
selectively etching aluminum layers from layered ternary carbide (Ti₃AlC₂) powder by adding the Ti₃AlC₂ powder in etchant to form a slurry;
centrifuging the slurry and washing the slurry until reaching a pH condition;
subsequent to reaching the pH condition, collecting a Ti₃C₂Tₓ MXene supernatant from the slurry;
vacuum drying the Ti₃C₂Tₓ MXene supernatant to produce Ti₃C₂Tₓ MXene powder;
mixing the Ti₃C₂Tₓ MXene powder with additional materials to form a nanocomposite ink with Ti₃C₂Tₓ MXene nanofillers; and
3D printing a pattern with the nanocomposite ink to form a Ti₃C₂Tₓ MXene nanocomposite spacer.

2. The method of claim 1, wherein the nanocomposite ink comprises a composition with 0.1-5 wt % of Ti₃C₂Tₓ MXene.

3. The method of claim 1, wherein the pH condition is a pH value of 6.

4. The method of claim 1, wherein the additional materials comprise a photopolymer, Tripropylene Glycol Diacrylate diluents, and a photoinitiator.

5. The method of claim 1, wherein the pattern comprises boundaries of shaped openings.

6. The method of claim 5, wherein the shaped openings comprise honeycomb-like hexagonal, square, diamond, triangular, circular, or rectangular openings.

7. A system comprising:
a (Ti₃C₂Tₓ) MXene nanocomposite spacer configured to absorb light and produce a thermal gradient to promote distilling of pure water from saline feed water, the nanocomposite spacer comprising a nanocomposite ink configured to be 3D printed, the nanocomposite ink comprising Ti₃C₂Tₓ MXene nanofillers.

8. The system of claim 7, wherein the nanocomposite material comprises a composition with 0.1-5 wt % of Ti₃C₂Tₓ MXene.

9. The system of claim 8, wherein the nanocomposite ink is further configured to be 3D printed in a pattern comprising boundaries of shaped openings.

10. The system of claim 9, wherein the shaped openings comprise honeycomb-like hexagonal, square, diamond, triangular, circular, or rectangular openings.

11. The system of claim 9, wherein the nanocomposite ink comprises a photopolymer, Tripropylene Glycol Diacrylate diluents, and a photoinitiator.

12. A membrane distillation (MD) system comprising:
a feed chamber exposed to a light source, the feed chamber comprising saline feed water;
a condenser chamber on an opposite side of the feed chamber relative to the light source, the condenser chamber comprising pure water; and
a (Ti₃C₂Tₓ) MXene nanocomposite spacer configured to be positioned between the feed chamber and the condenser chamber, absorb light from the light source, and produce a thermal gradient to promote distilling of pure water from the saline feed water.

13. The MD system of claim 12, further comprising an air gap configured to be positioned between the (Ti₃C₂Tₓ) MXene nanocomposite spacer and the condenser chamber.

14. The MD system of claim 12, wherein the nanocomposite spacer comprises a nanocomposite ink configured to be 3D printed, the nanocomposite ink comprising Ti₃C₂Tₓ MXene nanofillers.

15. The MD system of claim 14, wherein the nanocomposite ink further comprises a composition with 0.1-5 wt % of Ti₃C₂Tₓ MXene.

16. The MD system of claim 14, wherein the nanocomposite ink is configured to be 3D printed in a printed pattern.

17. The MD system of claim 16, wherein the printed pattern comprises boundaries of shaped openings.

18. The MD system of claim 17, wherein the shaped openings comprise honeycomb-like hexagonal, square, diamond, triangular, circular, or rectangular openings.

19. The MD system of claim 12, further comprising a hydrophobic distillation membrane.

20. The MD system of claim 19, wherein the hydrophobic distillation membrane comprises polyvinylidene fluoride, polypropylene, or polytetrafluorethylene.
